(19) United States
(12) Patent Application Publication
(10) Pub. No.: US 2010/0220633 A1
(43) Pub. Date: Sep. 2, 2010

(54) METHOD FOR ESTABLISHING A LOOP-FREE TREE STRUCTURE IN A DATA TRANSMISSION NETWORK AND ASSOCIATED NETWORK ELEMENT

(75) Inventors: Bernd Stilling, Munich (DE); Thomas Treyer, Munich (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG, Munich (DE)

(21) Appl. No.: 12/778,954

(22) Filed: May 12, 2010

Related U.S. Application Data
(63) Continuation of application No. 12/094,109, filed on Aug. 20, 2008.

(30) Foreign Application Priority Data
Nov. 16, 2005 (DE) 10 2005 054 673.0

(51) Int. Cl. H04L 12/28

(52) U.S. Cl. 370/256

(57) ABSTRACT

The invention relates to, among other things, a method during which a network element (58, 60) of a data transmission network (50) is automatically integrated into a method for establishing a loop-free tree structure or is automatically removed from such a method. By taking preset criteria into account, it is ensured that no loops can arise in the data transmission network (50) when removing a network element from the method for establishing a loop free tree structure.

### CLAIM FOR PRIORITY

This application is a continuation of U.S. Ser. No. 12/094,109, filed Aug. 29, 2008, which is a national stage application of PCT/EP2006/067985, filed Oct. 31, 2006, which claims the benefit of priority to German Application No. 10 2005 054 673.0, filed Nov. 16, 2005, the contents of which are hereby incorporated by reference.

### TECHNICAL FIELD OF THE INVENTION

The invention relates to a method for ascertaining a loop-free tree structure in a data transmission network.

### BACKGROUND OF THE INVENTION

A tree structure comprises what are known as nodes, which correspond to network elements, and branches, which are situated between two respective nodes and which correspond to connections between network elements. The network elements are switches or bridges, for example. A loop-free tree structure is present when there is no ring structure within the tress structure. Loop-free tree structures are required, by way of example, for a protocol layer 2, i.e., the physical layer, for example see IEEE (Institute of Electrical and Electronics Engineers) 802.1D, 1998, particularly section 8, where what is known as a spanning tree algorithm and an associated protocol are described.

However, the demand for loop-free tree structures also exists on higher protocol levels, for example, see protocol level 3, i.e., what is known as the network layer. Particularly with a very large number of network nodes in a data transmission network, the known algorithms converge only very slowly. On the other hand, manual or static termination of the involvement in the methods for ascertaining the loop-free structure is very critical, however, which is why the company Cisco requires the STP protocol to be retained even if it is unnecessary (“keep ST even if it is unnecessary”), for example.

Thus, a Carrier Ethernet network comprises more than 70 or even more than 100 network nodes, for example. The network topology usually ensures redundancy through the use of ring structures and mesh structures.

Methods such as STP (Spanning Tree Protocol) are used to manage these topologies. The use of STP is very complex and critical. STP and its later versions, such as RSTP (Rapid STP) and MSTP (Multi STP), have limited scalability. With the STP parameters which are prescribed in the standard, what is known as the network diameter is limited to 7 “hops”. Optimization of the STP parameters allows a network diameter of up to 19 hops to be attained, but this is still not sufficient for the requirements of a Carrier Ethernet network.

The basic functionality of STP or other protocol layer 2 methods (L2 methods) is not only error tolerance (resiliency). The basic functionality also involves keeping the layer 2 network loop-free under all circumstances. Loops need to be avoided in a layer 2 network for the following reasons:
what are known as broadcast frames are transmitted for an infinite length of time in the loops,
what are known as multicast frames are transmitted for an infinite length of time in the loops,
the duplication of the broadcast and multicast frames is continued until the maximum data transmission rate of the Ethernet network has been reached,
all connections are filled completely with broadcast data transmission traffic,
most of the queues or queuing memories in the network nodes are filled,
the control processors in the network nodes are overloaded,
user data traffic is transmitted at a very high frame loss data transmission rate,
user networks are flooded with broadcast and multicast messages, and
what is known as in-band management of the network is no longer possible.

In company networks, it has been found through experience that an incorrectly plugged patch cable, i.e. a cable with a length of less than ten meters, for example, or the addition of a new switch can unintentionally give rise to a loop, and the entire network thus collapses. For these reasons, STP is an unconditional requirement in company networks, even if layer 2 (L2) error tolerance (resiliency) is not used in the company.

A carrier network or operating network needs to guarantee loop-free operation. All network elements need to guarantee this with the standard parameters. If the network nodes and their parameters are reconfigured, loop-free operation should be guaranteed, even in cases of misconfiguration. Increasing the size of or changing the network should not result in loops, not even for a short time.

Hence, without any alteration, STP is not suitable for the required network sizes and is not able to support technologies in which a large number of access points are connected in a ring structure.

### SUMMARY OF THE INVENTION

The invention relates to a simple and improved method for ascertaining a loop-free tree structure. In addition, an associated network element is to be specified.

In one embodiment of the invention, a network element in a data transmission network automatically involves the network element in a method for ascertaining a loop-free tree structure or automatically removes the network element from such a method on the basis of at least one of the following or all of the following points: further network elements which are directly connected to the network element,
detection of the arrival or detection of the absence of data for ascertaining the loop-free tree structure, and
the function which is allocated to the network element in the loop-free tree structure.

Taking account of the indicated criteria ensures that loop-free operation is ensured even with reconfigurations and with incorrect replugging.

In another embodiment of the invention, the network elements are engaged on the basis of their basic configuration, which means that they are involved in STP. Alternatively, the network elements are removed from the STP method in the basic function. It is therefore not a question of the basic configuration, because it is possible to ascertain relatively quickly whether a network element needs to be involved in the STP method or needs to be removed from the STP method. A network element automatically detects whether or not an active STP entity is required for this specific network element. If a network element does not need to be involved in the STP method, this network element does not take part in the STP method, which is referred to as “STP pruning” (STP suppression). Only if the network element needs to be involved in the STP method is it involved in the STP method. In this way, it is possible to reduce the number of network elements which are involved in the STP method. This significantly increases the scalability of STP upward. The STP protocol itself is not changed, on the other hand.

The effectiveness of the invention is also dependent on the network topology. The invention is particularly effective in topologies in which a large number of network elements or of network nodes is connected to form a ring, particularly at the periphery of the network. Two examples of this are explained below with reference to the figures.

In one aspect, the invention is performed in various network elements in the same way. The various network elements may either be of the same design or have a different design from one another. This allows a program or a piece of hardware, for example, to be produced once and used multiple times for network elements which differ from one another. This also reduces the maintenance complexity for the program or the hardware.

In another aspect, the number of network elements which are directly connected to the network element is ascertained for the relevant network element. If the number is greater than two, the relevant network element is involved in the method for ascertaining the loop-free tree structure. If the number is equal to two or, in one refinement, less than three, on the other hand, then the network element is removed from the method for ascertaining the loop-free tree structure. This development is based on the consideration that with network elements in rings it is possible to ensure freedom from loops in another way too, for example by involving only one network element of the ring structure in an STP method.

In another embodiment of the invention, the network element is first removed from the method for ascertaining the loop-free tree structure. The start and end of a test period is stipulated. After the network element has been removed from the method for determining the loop-free tree structure, the arrival or the absence of data used for stipulating a loop-free tree structure is detected within the test period. These data are included in BPDUs (Bridge Protocol Data Units), for example. If such data are received within the test periods, the network element remains removed from the method because it is ensured that a network element which has sent the data carries out the STP and therefore ensures freedom from loops in the ring. If no such data are received within the test period, on the other hand, then after the test period has elapsed the network element is automatically involved in the method. This ensures that at least one network element in a ring, for example, carries out the STP method. Further methods make it possible to ensure that only precisely one network element in a ring structure carries out the STP method, even when the ring structure is not connected to any other network structure.

In still another embodiment, the network element is first involved in the method for ascertaining the loop-free tree structure. After the involvement, it is established that the network element forms the origin or the root of the loop-free tree structure. After this has been established, the network element remains involved in the method. If, when the network element has been involved, it is established that the network element is not the origin of the tree structure, on the other hand, then the network element is removed from the method again. This practice makes it possible to ensure, by way of example, that in a ring structure precisely one network element carries out the STP method, namely the network element which has been stipulated as the root of the loop-free tree structure in the ring structure. The development is particularly suitable for ring structures which are not connected to any other network structures of a data transmission network, i.e. for isolated ring structures.

In another aspect, the data for stipulating the loop-free tree structure are transmitted on the basis of what is known as the Ethernet protocol, see IEEE 802.3.

However, the invention can also be applied for other transmission protocols.

In another aspect, at least one network element is a multiplexer for broadband connections or at least one network element is an optical multiplexer. In this context, a broadband connection is a connection with a data transmission rate of greater than 500 kilobit/s in one transmission direction, as are used in conjunction with xDSL (x Digital Subscriber Line) methods, where x indicates a specific DSL method, e.g. ADSL (Asymmetrical DSL).

In yet another aspect, the method for ascertaining the loop-free tree structure is a spanning tree method, particularly:

the method based on IEEE 802.1D (STP),

the method based on IEEE 802.1w (RSTP), or

the method based on IEEE 802.1s (MSTP).

However, the invention can also be used for other methods for ascertaining loop-free tree structures, particularly also on higher protocol levels.

In still another aspect, the data are transmitted on the basis of an optical transmission method. By way of example, data in optical data transmission networks can also be transmitted on the basis of the Ethernet protocol.

The invention also relates to a network element whose operation involves the inventive method or one of its developments being carried out. Hence, the technical effects cited above also apply to the network element.

### BRIEF DESCRIPTION OF THE DRAWINGS

The text below explains exemplary embodiments of the invention with reference to the appended drawings, in which:

FIG. 1 shows steps for automatically removing or involving a network element from a method for ascertaining a loop-free tree structure.

FIG. 2 shows the structure of an access data transmission network.

FIG. 3 shows the topology of the data transmission network shown in FIG. 2.

FIG. 4 shows an optical data transmission network or an optical carrier data network.

FIG. 5 shows the optical data transmission network shown in FIG. 4 from a point of view of a data communication network.

FIG. 6 shows the topology of the data transmission network shown in FIG. 4.

### DETAILED DESCRIPTION OF THE INVENTION

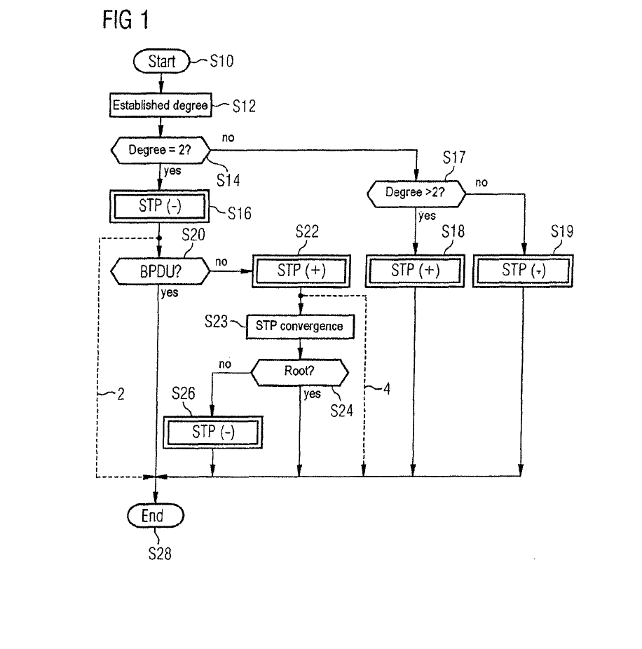

FIG. 1 shows steps for automatically removing and involving a network element from a method for ascertaining a loop-free tree structure. The method begins in step S10. In step 510, STP is in a turned-off state for the relevant network element or STP is turned off in step 510. In subsequent step S12, the network element in which the steps are performed establishes how many other network elements are directly adjacent to the relevant network element. This number is subsequently also referred to as degree.

A step S14 tests whether the degree ascertained in step S12 is equal to two. If this is not the case, step S14 is followed immediately by a step S17. Step S17 tests whether the degree is greater than two. If this is the case, step S17 is followed immediately by a step S18, in which the STP method is turned on in the relevant network element, so that this network element is involved in ascertaining the loop-free tree structure for the data transmission network. After step S18, the method is terminated in a step S28 for the time being until a change in the topology of the data transmission network occurs, for example. If, on the other hand, step S17 establishes that the degree is not greater than two, i.e. the degree is 0 or 1, then step S17 is followed immediately by a step S19, in which the STP is turned off for the relevant network element in which the steps shown in FIG. 1 are carried out.

If, on the other hand, step S14 establishes that the degree ascertained in step S12 is equal to two then step S14 is followed directly by a step S16, in which STP is turned off for the relevant network element. As indicated by an arrow 2, this is followed by step S28, in which the method is terminated, so that the STP method is not performed in the relevant network element. The relevant network element is therefore disregarded when ascertaining a loop-free tree structure.

The method shown in FIG. 1 is performed for network elements or network nodes in a data transmission network, for example. However, it is also manually possible to stipulate individual network elements which are not involved, for example. The result of a first variant V1 is that network elements which have more than two adjacent network nodes are involved. On the other hand, network elements which have only two, only one or no adjacent network element, particularly network elements which have only two neighbors in a ring, are removed from the method. In another exemplary embodiment of variant V1, the check in step S17 is performed instead of the check in step S14, with “yes” prompting a branch to step S18. “no” prompts a branch to step S16. Step S19 is not required in this other exemplary embodiment.

In other words, every network element counts the number of active NNI (Network Network Interface) ports. In this context, an active NNI port is an NNI port with the connection status “up and running”. The role of the relevant network element and its properties are ascertained on the basis of the number of detected NNIs:
≧3 NNIs:
   if the number of NNIs is >2, STP/RSTP is executed for the relevant network element.
2 NNIs:
   if the number of NNIs is precisely two, these two ports are treated as ring ports by the network element:
      the STP protocol is turned off for this network element,
      BPDUs (Bridge Protocol Data Units) which are received on a ring port are forwarded transparently to the other ring port. These BPDUs are preferably forwarded with higher priority than other frames. The aim is to forward these BPDUs in fewer than 5 milliseconds at maximum load, for example.
      the learning of MAC (medium access) addresses is turned off completely on the ring ports. From that point on, the network element is no longer a bridge in the ring. It now operates only as a hub or as a distributor unit for data packets. Consequently, every frame coming from a user is simultaneously forwarded in both ring directions. Therefore, the network element no longer needs to evaluate the “topology changed” notifications of the STP protocol. In the opposite transmission direction, i.e. from the network to a user, the bridge function is still active, on the other hand. A frame transmitted in the downlink to a local user is forwarded only to this user and is not forwarded in the ring.
1 NNI:
   if the number of NNIs is precisely 1, the network element classifies itself as what is known as a leaf node or edge node in the access network. No BPDUs are produced or interpreted on the NNI port. All BPDUs which are received on the single NNI port are discarded without handling it.
0 NNI:
   the network element has no connection to other network elements, for example data transmission is possible only directly between two connected subscribers or users.

Every event used to plug or remove a connection on an NNI port results in recalculation of the number of NNI ports. As soon as the number of NNI ports changes, the role and properties of the network element change accordingly.

In a variant V2, the following steps are executed in addition to the steps explained with reference to FIG. 1, the step executed by the dashed arrow 2 not being executed. If step S14 establishes that the degree ascertained in step S12 is not greater than two, step S14 is followed immediately by step S16 again, in which the STP is deactivated for the relevant network element. In the case of variant V2, step S16 is followed immediately by a step S20, in which the relevant network element tests whether BPDUs are received. If this is not the case, step S20 is followed immediately by a step S22. Step S22 activates the STP for the relevant network element. In variant V2, step S22 is followed by the method being terminated in step S28, see dashed arrow 4.

If, on the other hand, step S20 establishes that the relevant network element receives BPDUs, step S20 is followed immediately by step S28, i.e. the method is terminated, the STP remaining turned off for the relevant network element.

In another exemplary embodiment, variant V2 is also executed without the steps of variant V1, whose function is then performed by other methods.

Variant V2 and also a variant V3, explained below, are used particularly when network elements in the data transmission network are in a ring structure. This is because if the network elements which form the ring execute the method based on variant V1 (STP pruning), the ring would no longer be loop free. At least one network element in the ring should perform STP. In typical networks, such as access networks, such a topology does not need to be considered. An access ring has at least one network element with a connection to the core data transmission network, which results in at least one network element having three NNI ports. If the connection to the core is lost, services are interrupted, regardless of whether or not there is a flood of broadcast messages.

Nevertheless, variants V2 and V3 are explained, which also allow loop-free operation of the network in such cases, for example.

In the case of variant V2, which has already been explained, every network element with precisely two NNI ports will suppress the STP (STP pruning). In this mode of operation, each of these network elements checks whether STP-BPDUs are present in the ring. A timing circuit (timer) is reset with every BPDU received at an NNI input (NNI Ingress). However, if the timing circuit reaches its end value without a BPDU having been received, STP is turned on for the relevant network element. By way of example, the end time is five times what is known as the “hello time” of BPDUs, which is two seconds, for example.

This practice ensures that at least one network element in the ring structure performs STP. However, it may randomly also be a plurality of network elements. To ensure that only precisely one network element performs STP, a variant V3 is carried out which is explained below.

In the case of variant V3, the method steps explained with reference to variant V1 and variant V2 are carried out, but with the steps shown by arrows 2 and 4 not being carried out. In variant V3, step S22 is followed immediately by a step S23, which involves waiting until the root network element in the data transmission network has been determined. This is then followed by a step S24. In step S24, the relevant network element ascertains whether it has become what is known as the root of a loop-free tree structure. If this is the case, step S24 is followed immediately by step S28, in which the method is terminated, the STP remaining turned on for the relevant network element.

If, on the other hand, step S24 establishes that the relevant network element has not become the root of the loop-free tree structure, step S24 is followed immediately by a step S26. Step S26 turns off the STP for this network element. The method is then terminated in step S28.

In other words, if the network element can assume that the method for selecting the root bridge has concluded, it tests whether or not it has become the root bridge. If the network element has not become the root bridge and still has no more than two NNIs, the network element deactivates STP again. In particular, what is known as the “forward delay timer” of the STP indicates the time which is required for selecting a bridge.

The following processes take place in a ring:
1. A ring without STP is formed, i.e. the last patch cable is plugged in,
2. A multiplicity of broadcast messages (broadcast storm) are triggered,
3. No BPDUs are produced,
4. One or more network element decide that no STP has been activated in the ring yet and activate STP themselves. The ring ports on these network elements are blocked with regard to the typical STP timing values such as learning delay or forwarding delay.
5. A root bridge is selected,
6. The ring ports enter what is known as the forwarding mode of operation apart from one port.
7. The network elements apart from the root bridge (Bridge) deactivate STP.
8. A single network element executes STP in the ring, namely the network element which is also the root of the loop-free tree structure.

Variant V3 is also executed without the method steps of variant V1 and without the method steps of variants V1 and V2 in another exemplary embodiment.

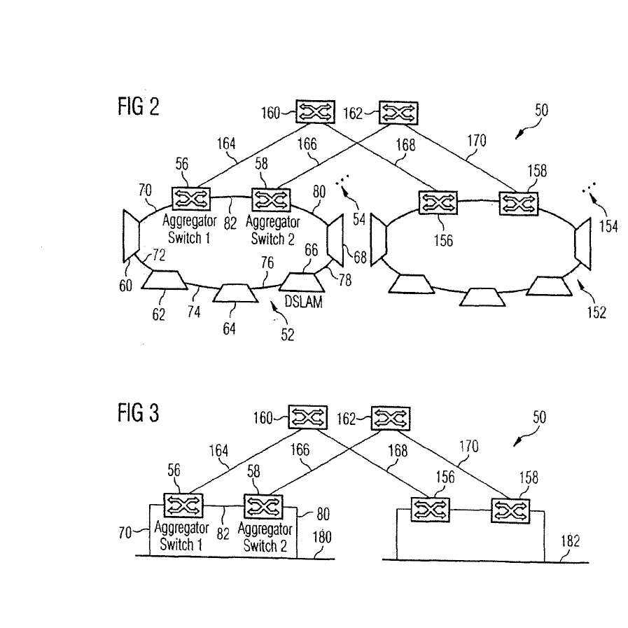

FIG. 2 shows the structure of an access data transmission network 50. The data transmission network 50 includes a multiplicity of data transmission rings 52, 54 and also 152 and 154 and also other ring structures (not shown) at its periphery. In the data transmission ring 52, two aggregation units 56, 58 and also five multiplexers 60 to 68 are connected together to form a ring using Ethernet lines 70 to 82. The aggregation units 56, 58 are also called an aggregator switch. By way of example, aggregation units of type SURPASS hiD 6650 from the company Siemens AG™ can be used which have been extended by units which can be used to execute the method steps explained in FIG. 1. The multiplexers 60 to 68 are also called DSLAMs (Digital Subscriber Line Access Multiplexers). By way of example, it is possible to use SURPASS hiX 5630 and 5635 units from the company Siemens AG. Alternatively, however, it is also possible to use units from other companies for the aggregation units 56, 58 and for the multiplexers 60 to 68. In addition, the data transmission ring 52 includes other multiplexer units (not shown). The data transmission rings 54 are likewise connected to the aggregation units 56 and 58.

The data transmission ring 152 likewise includes a multiplicity of multiplexer units and also two aggregation units 156 and 158 connected up in a ring form using Ethernet lines. The data transmission rings 154 are likewise connected to the aggregation units 156 and 158. Every data transmission ring 52, 152, 54, 154 includes two aggregation units for reasons of redundancy.

In addition, the data transmission network 50 includes two aggregation units 160 and 162, for example SURPASS hiD 6650 and 6670 units from the company Siemens AG™. The aggregation unit 160 is connected to the aggregation unit 56 by means of an Ethernet line 164 and to the aggregation unit 156 by means of an Ethernet line 158. The aggregation unit 162 is connected to the aggregation unit 58 by means of an Ethernet line 166 and to the aggregation unit 158 by means of an Ethernet line 170. In addition, the data transmission network 50 contains further network elements which are connected to the aggregation units 160 and 162.

Instead of the multiplex units 60 to 68, it is also possible to use optical line termination units, i.e. OLTs (Optical Line Terminators). An access network includes a large number of multiplexers, (DSLAMs) and OLTs, which are used to gather and distribute the traffic from thousands of users to form an IP backbone, for example. For redundancy reasons, the DSLAMs/OLTs are connected up to form ring structures. By way of example, the access rings are connected to the core of the aggregation network using two respective aggregation units 56, 58, 156, 158. From the point of view of the standard STP, the topology shown in FIG. 2 has sixteen “hops” or forwarding units for the data transmission rings 52 and 152. This means that the limit to scaleability for STP has already been reached. However, a special feature of the topology is that the DSLAMs 60 to 68 each have two ring ports as a connection to the access network. It is therefore possible to turn off STP in these DSLAMs 60 to 68 without adversely affecting the redundancy or the freedom from loops. This practice results in the topology shown in FIG. 3.

FIG. 3 shows the topology produced for data transmission network 50 when the method shown in FIG. 1 is executed for each network element. From the point of view of the STP, the DSLAMs 60 to 68 are no longer bridges but rather what are known as hops, i.e. distribution units 180 and 182. The aggregation units 56 and 58 are now connected to the same hub 180 from the point of view of the STP. However, this is a valid topology for STP. The number of forwarding units has reduced from sixteen “hops” to six hops. This means that the STP method converges more quickly and safe convergence can be ensured initially.

As can be seen from FIG. 3, STP is carried out in the aggregation units 56, 58, 156, 158, 160 and 162, i.e. in network nodes which have at least three connections to adjacent network units. On the other hand, STP is not performed in the multiplexers 60 to 68, since these each have two adjacent network elements.

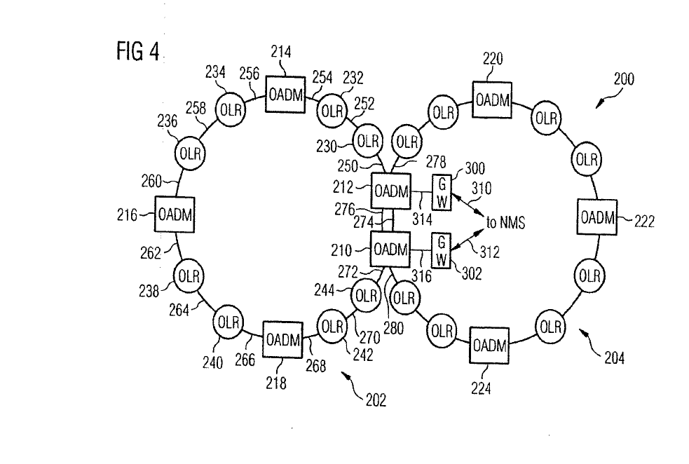

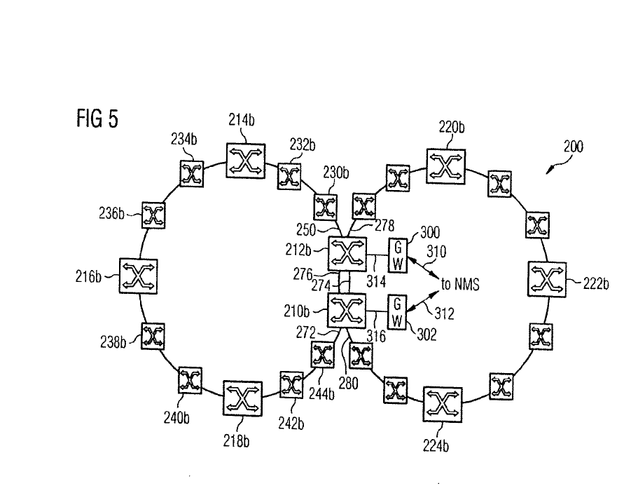

FIG. 4 shows an optical data transmission network 200 which is operated by a network operator. The data transmission network 200 includes two glass fiber data transmission rings 202 and 204 and also a multiplicity of further glass fiber links (not shown).

In the data transmission ring 200, for example, five optical multiplexer units 210 to 218 are connected to form a ring structure. The multiplexers 210 and 212 are in duplicate form for redundancy reasons and are used for redundantly coupling the two data transmission rings 202, 204 and also for redundant access by a network management system (NMS). If the multiplexers 210 and 212 are regarded as one multiplexer, the data transmission ring 202 between two respective adjacent multiplexers 212 to 218 includes, by way of example, two or more than two amplifier units 230 to 244 which are connected together using optical transmission lines 250 to 272. One optical transmission line 274 of the data transmission ring 202 is situated between the multiplexers 210 and 212. In addition, one transmission line of the data transmission ring 202 is situated between the multiplexers 210 and 212.

The multiplexer units 210 to 218 are, by way of example, multiplexer units of type SURPASS hiT 7300 from the company Siemens AG. These multiplexer units are also referred to as “add-drop multiplexers”. By way of example, the amplifier units 23C to 244 are amplifier units of type SURPASS hiT 7300 from the company Siemens AG™. However, it is also possible to use units from other companies for the multiplexers 210 to 218 and for the amplifier units 230 to 244.

The data transmission ring 204 is of similar design to the data transmission ring 202, see the multiplexers 210, 212 and further multiplexers 220, 222 and 224, for example.

The multiplexers 210 and 212 form a core data transmission network which is also called a backbone. The multiplexers 214 to 218 and the multiplexers 220 to 224 are, by contrast, connected to further units (not shown), from which they gather data and to which they distribute data. By way of example, a data transmission ring 202 is used to transmit more than 50 transmission channels, particularly 80 transmission channels, at a data transmission rate of in each case more than 20 Gbit/s, particularly 40 Gbit/s. Such data transmission methods are also called DWDM (Dense Wavelength Division Multiplexing) methods. In another exemplary embodiment, a WDM (Wavelength Division Multiplexing) method, an SDH (Synchronous Digital Hierarchy) method, a SONET method or another suitable method is used instead of the DWDM method.

A data transmission channel in the data transmission rings 202 and 204 is used for managing the multiplexers and amplifier units, however. A network gateway unit 300 is connected to the multiplexer 212, for example via a line 314. Similarly, the multiplexer 214 is connected to a network gateway unit 302 via a line 316. From the network gateway unit 300 or the network gateway unit 302, a line 310 or 312 is routed to a network management system NMS.

A transmission channel in the optical data transmission network 200 is used in each data transmission ring 202 or 204 for controlling the network. This data transmission channel is used to transmit data on the basis of the Ethernet protocol, for example.

FIG. 5 shows the optical data transmission network 200 from the point of view of the control network, which operates on an Ethernet basis. From the point of view of the control network, the multiplexers 210 to 224 and the amplifier units 230 to 244 are what are known as switches or bridges, which is illustrated in FIG. 5 by reference symbols with suffixed lower-case letters b, see multiplexer 214b, for example, which corresponds to the multiplexer 214.

Hence, FIGS. 4 and 5 show a typical DWDM network with two redundantly connected data transmission rings 202, 204. The network elements are: optical add-drop multiplexers (OADM) 210 to 224 and optical line repeaters (OLRs) 230 to 244. For redundancy reasons, the network management system NMS is connected to the DWDM network via two gateways (GW) 300 and 302. The gateways 300, 302 isolate the internal data communication network (DON) from the external carrier data network (CDN). The gateways 300, 302 conceal the internal IP addresses of the internal DCN, provide what is known as a firewall and have other functions. The carrier data network transmits user data, such as music data, video data, voice data and program data. By contrast, the DCN transmits predominantly control data.

FIG. 5 shows the data transmission network 200 from the point of view of the DCN. In contrast to a routing network, the DCN is in the form of a “switched” network. To keep the data transmission network 200 shown in FIG. 5 loop free, standard STP must have been activated on all network elements, so that there are then 24 STP instances in this example. However, so many STP entities would drastically increase the convergence time of STP.

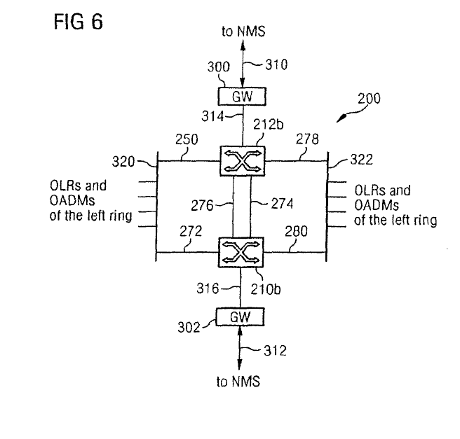

On account of the ring-based topology of the network 200, however, a large number of network elements have only two ring ports or ring connections. It is therefore in turn possible to turn off STP in these network nodes without adversely affecting the redundancy or the avoidance of loops. From the point of view of the STP, the network shown in FIG. 6 is then obtained.

FIG. 6 shows the topology of the data transmission network 200 as stipulated using the method explained with reference to FIG. 1. Accordingly, in the data transmission ring 202, STP is turned off in the multiplexers 214, 216 and 218 and also in the amplifier units 230 to 244. In terms of the STP method, these units present themselves as a distribution unit 320 which is connected to the multiplexer 212b via the optical data transmission lines 250 and to the multiplexer 210b via the data transmission line 272.

In the data transmission ring 204, on the other hand, STP has been deactivated in the multiplexers 220, 222 and 224 and also in the amplifier units of the data transmission ring 204, so that, in terms of the STP method, these units present themselves as a distribution unit 322 or as hubs. The distribution unit 322 is connected to the multiplexer 212b via the optical data transmission line 278 and to the multiplexer 210b via the optical data transmission line 280.

In the multiplexers 212b and 210b, on the other hand, the STP method has been activated, particularly in order to avoid loops for the transport of data packets in the data transmission ring 202 or in the data transmission ring 204. The topology shown in FIG. 6 now has two network nodes and “hops”. This means that the convergence time of the STP method is significantly reduced in this case too.

For other embodiments, the following holds true:
1.) While the network is changing in transition states, the number of NNIs for an individual network element may change, so that STP is activated or deactivated. If the transition reduces the number of NNIs, the transition is uncritical. If the number of NNIs is increased from two NNIs to three or more than three NNIs, the freshly activated port should initially be blocked. In a subsequent step, STP is activated on the network element. If the loop-free tree has been calculated, the freshly activated port is enabled (unlocked) on the basis of the STP.
2.) Turning off the MAC address learning in the ring ports has the effect that every downlink frame is sent in both ring directions. The unnecessarily produced data traffic is transmitted by the ring as far as a blocked port on an aggregation unit, where STP has broken the ring in order to avoid loops in the transmission of data. Depending on the volume of traffic, the uplink data traffic on a ring node may overlap the downlink data traffic on another ring node. In rare cases, this may result in a reduction in the available bandwidth. However, significantly greater influence on the bandwidth in the ring is had by the fact that the ring is not broken at an optimum point by STP, for example.
3.) A guard time for RSTT can be stipulated empirically.
4.) For a stable network operation, the root bridge should not be changed often. For this reason, the root bridge and the redundant root bridge should not perform STP suppression.
5.) The proposed methods can be activated or deactivated. The standard value is activated. If the algorithm is deactivated, the network element performs STP, regardless of the current number of active NNIs for this network element.
6.) What is known as link aggregation can be used in order to increase the available bandwidth on a link. In these cases, aggregated connection counts as an active NNI. To allow this, link aggregation and LACP (Link Aggregation Control Protocol) should be allowed as standard on the ports.
7.) A network element can have a “subtending” interface to other network elements. In this case, the subtending interface is counted as an NNI port. Cascaded interfaces are likewise counted as an NNI. The reason for this is that the topology also supports what is known as dual homing for “subtended” network elements. This can be brought about intentionally or unintentionally, so that what is known as a plug-and-play method should treat a “subtending” interface as an NNI port.

The methods explained avoid a dilemma which would occur with a static configuration: firstly, the network would not be loop free without configuration. Secondly, without a loop-free network, no configuration by in-band management can be performed. By contrast, the methods explained make it possible to ensure freedom from loops even if a plug-and-play change to the network occurs.

The methods explained also take account of the following considerations. When a network element has been booted, all of its ports are disabled. In the next step, the network element detects the role of each of its ports. Two roles are significant:
What is known as a peripheral leaf port is located on the boundary of a network. A loop can never arise via a leaf port because a leaf port is not connected to any other switch in the same network.
If a port is not a leaf port, it is called an NNI (Network Network Interface) port. An NNI port can be connected to other switches and therefore holds the risk of loop formation.

The standard STP approach treats all ports as NNI ports in order to be safe. Therefore, STP operates outstandingly in all topologies. RSTP adds the possibility of stipulating ports as leaf ports (operEdgePort is TRUE) through configuration. Switches or forwarding units for digital data which are provided for specific applications may have additional possibilities, however, in order to automatically detect whether they have leaf ports without configuring them manually for this purpose.

Two examples have been given above:
An access network which includes DSLAMs or OLTs and aggregation units. The aggregation units or aggregation switches have NNI ports. By contrast, the DSLAMs or OLTs need to be assessed more accurately. The user ports are leaf ports by definition. It can safely be assumed that there are no loops in the data transmission via user ports or subscriber ports. Even if there is a loop between two users, the effects of such a loop will remain limited to the specific user, for example as a result of the application of filters and controlling functions such as MAC address limitations, blocking of multicast and what is known as address antispoofing. It is thus possible for all user ports in a DSLAM or OLT to be treated as leaf ports. For a DSLAM or OLT, the ports for the downlink data traffic have the role of an NNI. For an Ethernet access switch with a large number of Fast Ethernet ports and with a few Gbit ports, such as the type hiD 6610 from the company Siemens AG™, it can be assumed
that Fast Ethernet ports are leaf ports and that Gbit ports are NNI ports.
For DCN in WDM systems or DWDM systems, on the other hand, it holds that besides the NNI ports which connect a network element to another network element there are ports on which there are connections to the NMS and/or to a local configuration terminal (local craft terminal). The external NMS/LCT Ethernet ports and the internal DCN have gateways between them. In this case, it is not possible to complete a loop via the external port, because there is the gateway. Without the configured gateway on the external NMS/LCT Ethernet port, it is down to a user to avoid loops via this interface.

1. A method for ascertaining a loop-free structure in a data transmission network, comprising:
automatically including or removing a network element in the data transmission network based on at least one of the following:
a number of additional network elements which are directly connected to the network element,
detection of arrival or absence of data for ascertaining the loop-free tree structure, and
allocation of the function to the network element in the loop-free tree structure.

2. The method as claimed in claim 1, wherein the method is performed in other network elements in a same way.

3. The method as claimed in claim 1, further comprising
ascertaining the number of additional network elements which are directly connected to the network element for the network element, wherein
if the number is greater than two then the network element is involved in the method for ascertaining the loop-free tree structure, and
if the number is equal to two or less than three then the network element is removed from the method for ascertaining the loop-free tree structure.

4. The method as claimed in claim 1, further comprising
removing the network element from the method for ascertaining the loop-free tree structure; and
in that a test period, wherein
if data for ascertaining the loop-free tree structure on the network element is received within the test period and after the network element has been removed from the method for ascertaining the loop-free tree structure, then
after the data have been received, the network element remains removed from the method, and
if no data for ascertaining the loop-free structure are received on the network element within the test period and after the network element has been removed from the method for ascertaining the loop-free tree structure, then
after the test period has elapsed the network element is involved in the method for ascertaining the loop-free tree structure.

5. The method as claimed in claim 1, further comprising:
involving the network element in the method for ascertaining the loop-free tree structure, wherein
if after the involvement is established, the network element forms the origin of the tree structure, then
the network element remains involved in the method for ascertaining the loop-free tree structure, or
if after the involvement of the network element in the method for ascertaining the loop-free structure is established the network element does not form the origin of the tree structure, then
the network element is removed from the method for ascertaining the loop-free tree structure.

6. The method as claimed in claim 1, wherein the data are transmitted on the basis of the Ethernet protocol.

7. The method as claimed claim 1, wherein at least one network element is a multiplexer for broadband connections or in that at least one network element is an optical multiplexer.

8. The method as claimed in claim 1, wherein the method for ascertaining a loop-free tree structure is a spanning tree method.

9. The method as claimed in claim 1, wherein the data are transmitted on the basis of an optical data transmission method.

10. A network element comprising a control unit which automatically involves or removes the network element in a method for ascertaining a loop-free tree structure, wherein the control unit operates according to:
the number of additional network elements which are directly connected to the network element,
detection of the arrival or detection of the absence of data for ascertaining the loop-free tree structure, and
the function which is associated with the network element in the loop-free tree structure.

11. The network element as claimed in claim 10, wherein the control unit includes a unit to perform the following:
removing the network element from the method for ascertaining the loop-free tree structure; and
stipulating a test period, wherein
if data for ascertaining the loop-free tree structure on the network element is received within the test period and after the network element has been removed from the method for ascertaining the loop-free tree structure, then
after the data have been received, the network element remains removed from the method, and
if no data for ascertaining the loop-free structure are received on the network element within the test period and after the network element has been removed from the method for ascertaining the loop-free tree structure, then
after the test period has elapsed the network element is involved in the method for ascertaining the loop-free tree structure.

12. The network element as claimed in claim 10, wherein the control unit includes a unit to perform the following:
involving the network element in the method for ascertaining the loop-free tree structure wherein
if after the involvement is established, the network element forms the origin or root of the tree structure, then the network element remains involved in the method for ascertaining the loop-free tree structure, or
if after the involvement of the network element in the method for ascertaining the loop-free tree structure is established the network element does not form the origin of the tree structure, then the network element is removed from the method for ascertaining the loop-free tree structure.

13. The network element as claimed in claim 10, wherein the control unit includes a unit to perform the following:
ascertaining the number of additional network elements which are directly connected to the network element for the network element, wherein
if the number is greater than two then the network element is involved in the method for ascertaining the loop-free tree structure, and
if the number is equal to two or less than three then the network element is removed from the method for ascertaining the loop-free tree structure.
